(19) United States
(12) Patent Application Publication
(10) Pub. No.: US 2007/0141462 A1
(43) Pub. Date: Jun. 21, 2007

(54) Method and apparatus for reducing water loss

(75) Inventors: Shengxian Wang, Shanghai (CN); Chang Wei, Niskayuna, NY (US); John Lemmon, Schoharie, NY (US)

Correspondence Address: SHENGXIAN WANG, ROOM 401, BUILDING 2,318, SANMEN ROAD, SHANGHAI, CN

(73) Assignee: General Electric Company

(21) Appl. No.: 11/314,268

(22) Filed: Dec. 21, 2005

(51) Int. Cl. H01M 10/26; H01M 8/08

(52) U.S. Cl. 429/206; 429/347; 429/46

(57) ABSTRACT

An electrochemical cell is provided. The cell may include at least one anode; at least one cathode; and an electrolyte composition contacting the anode and the cathode. The electrolyte composition may include an alkali and a hydrophilic additive having one or more functional groups effective for bonding with water.

### FIELD

Embodiments of the invention may relate to an apparatus for reducing water loss in a fuel cell or battery. Embodiments may relate to a method for reducing water loss in a fuel cell or battery.

### BACKGROUND

It may be problematic to achieve and maintain a balance of water usage relative to water generation in a fuel cell or metal air battery. Water evaporation may occur in an electrochemical cell that is not closed to the environment. Water evaporation may upset the balance of water usage and water generation in the fuel cell, and may reduce performance of the electrochemical cell.

Water loss has been reduced for some fuel cells or metal air batteries by restricting the size of openings into the fuel cell. The openings may be as small as a few dozen micrometers in diameter. The restricted opening may reduce water evaporation, but may also restrict gas flow. A fan may be added to move gas and vapor within the fuel cell to overcome the restricted opening size. But, the fan may reduce efficiency of the fuel cell because the fan requires energy from the fuel cell to operate.

Other cells may include a membrane that is pervious to oxygen but not to water vapor. But, such a membrane may have an undesirably high gas flow resistance. Such a high resistance may reduce fuel cell efficiency. Additionally, the separation of oxygen and water in fuel cells having this membrane has not been adequate for application to batteries and some fuel cell embodiments.

It may be desirable to have a fuel cell and/or a metal/air battery having differing component, characteristics or properties than those currently available.

### BRIEF DESCRIPTION OF THE INVENTION

Embodiments of the invention described herein may include an electrochemical cell. The cell may include at least one anode, at least one cathode, and an electrolyte composition contacting the anode and the cathode. The electrolyte composition may include an alkali and a hydrophilic additive. The hydrophilic additive may have one or more functional groups effective for bonding with water.

Another embodiment may include a method for reducing water loss in an electrochemical cell that may include an electrolyte. The method may include adding a hydrophilic additive to the electrolyte. The hydrophilic additive may include one or more functional groups effective for bonding with water.

One embodiment may include a method for stabilizing relative humidity in an electrochemical cell that may include an electrolyte. The method may include adding a hydrophilic additive to the electrolyte. The hydrophilic additive may include one or more functional groups effective for bonding with water.

### BRIEF DESCRIPTION OF THE DRAWINGS

Throughout the drawings, like elements are given like numerals.

FIG. 1 illustrates a schematic view of a fuel cell that may include an electrolyte additive described herein.

FIG. 2 illustrates a graphical view of water evaporation rate for pure water, over relative humidity values of 50 percent, 65 percent, 80 percent and 95 percent.

FIG. 3 illustrates a graphical view of water evaporation rate for 6 mol/L KOH solution over relative humidity values of 50 percent, 65 percent, 80 percent and 95 percent.

FIG. 4 illustrates a graphical view of water evaporation rate for 6 mol/L KOH solution, with a hydrophilic additive of 2 percent sodium polyacrylate, over relative humidity values of 50 percent, 65 percent, 80 percent and 95 percent.

FIG. 5 illustrates a graphical view of water evaporation rate for 6 mol/L KOH solution, with a hydrophilic additive of 5 percent sodium polyacrylate, over relative humidity values of 50 percent, 65 percent, 80 percent and 95 percent.

FIG. 6 illustrates a graphical view of conductivity versus sodium acrylate additive concentration in a 6 mol/L KOH solution, tested by an electrochemical impedance method.

FIG. 7 illustrates a graphical view of cyclicvoltammetric curves for sodium polyacrylate in 6 mol/L KOH solution.

### DETAILED DESCRIPTION OF THE INVENTION

Embodiments of the invention may relate to an apparatus for reducing water loss in a fuel cell or battery. Embodiments may relate to a method for reducing water loss in a fuel cell or battery.

Although detailed embodiments of the invention are disclosed herein, it is to be understood that the disclosed embodiments are merely exemplary of the invention that may be embodied in various and alternative forms. Specific structural and functional details disclosed herein are not to be interpreted as limiting, but merely as a representative basis for teaching one of ordinary skill in the art to variously employ embodiments of a method or an apparatus for reducing water loss.

As used herein, the term membrane may refer to a selective barrier that permits passage of protons generated at the anode through the membrane to the cathode for reduction of oxygen at the cathode to form water and heat. The terms cathode and cathodic electrode refer to a metal electrode that may include a catalyst. At the cathode, or cathodic electrode, oxygen from air is reduced by free electrons from the usable electric current, generated at the anode, that combine with protons, also generated by the anode, to form water and heat.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

Electrochemical cell embodiments, as is used herein, refer to assemblies of two electrodes connected by an electrolyte which forms an ion path between the electrodes. Electrochemical cells include voltaic cells, and batteries. Fuel cells, including rechargeable fuel cells and metal air batteries, and their stacks, are also types of electrochemical cell embodiments.

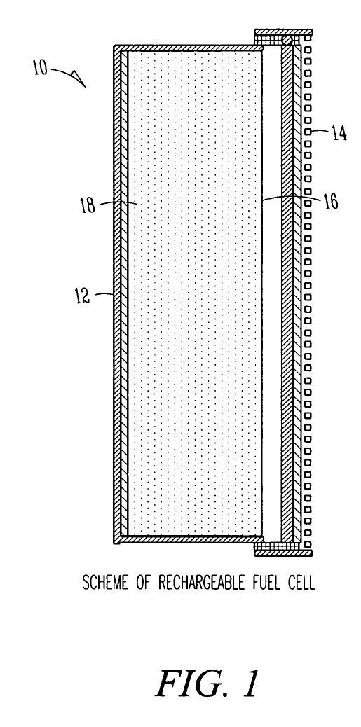

With reference to FIG. 1, the electrochemical cell may include a galvanic cell 10. The galvanic cell 10 may include an anode shell 12, a cathode shell 14, a membrane 16, and an electrolyte 18. The anode and the membrane may be in contact with the electrolyte and at least one surface of a catalyst layer that forms a part of the cathode.

The cathode in the fuel cell embodiments described herein may be metal or graphite, or another carbon-based material. In one embodiment, a rechargeable fuel cell or metal/air battery has a base solution as an electrolyte. A suitable base solution may include potassium hydroxide. Suitable anode materials be stabilized in such a base solution. A suitable base solution-stable anode material may be a metal hydride.

The electrolyte may include an aqueous alkaline material. Suitable alkaline material may include potassium hydroxide (KOH) of sodium hydroxide (NaOH). In one embodiment, the alkaline material is essentially free of sodium and/or chlorine ions.

The electrolyte may further include a hydrophilic additive. Suitable hydrophilic additives may include a polyacrylate, for example, sodium polyacrylate (PAA Na) CAS#: 9003-04-7. Additionally or alternatively, other suitable hydrophilic additives may include one or more alcohols, amines, ethers, or cellulosics. Suitable alcohols may be polyols, such as polyethylene glycol or. In one embodiment, the hydrophilic additive may include one or more of glycerin, carboxymethyl cellulose (CMC), or polyethylene oxide. In one embodiment, the hydrophilic additive may include one or more of polyacrylamide, polyvinyl alcohol or poly(vinyl acetate). The hydrophilic additives may include one or more functional groups that are effective for bonding with water. Suitable functional groups may include one or more of OH—, carboxyl, ether, and NH— functional groups. In one embodiment, more than one type of functional group is present on a single molecule.

The PAA Na, glycerin, polyethylene oxide, carboxymethyl cellulose (CMC), alcohols and amine additives may be soluble in water. The chemical formula for PAA Na is shown below:
—[CH₂—CH(COONa)]ₙ.

The chemical formula for carboxymethyl cellulose (CMC) is shown below:

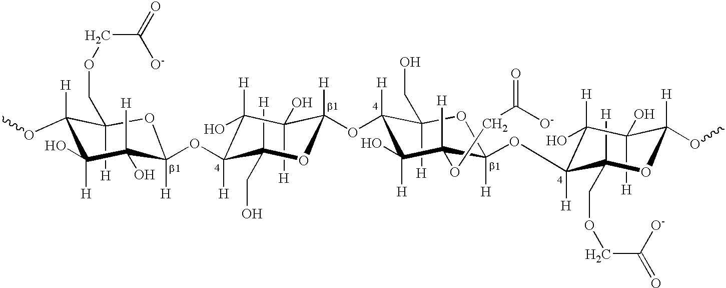

Suitable hydrophilic additives may have a molecular weight of up to about 3,000,000. In one embodiment, the hydrophilic additive average molecular weight may be in a range of from about 50,000 to about 500,000; from about 500,000 to about 750,000; from about 750,000 to about 1,000,000; from about 1,000,000 to about 1,500,000; from about 1,500,000 to about 2,000,000; from about 2,000,000 to about 2,500,000; from about 2,500,000 to about 2,750,000; or from about 2,750,000 to about 3,000,000.

The hydrophilic additive may be present in the electrolyte in a concentration effective for reducing water evaporation from the electrochemical cell. The hydrophilic additives may be present in the electrolyte in an amount of up to about 95 weight percent based on the weight of the electrolyte. In one embodiment, the hydrophilic additive may be present in the electrolyte in an amount in a range of from about 0.5 weight percent to about 1.5 weight percent, from about 1.5 weight percent to about 2.5 weight percent, from about 2.5 weight percent to about 5 weight percent, from about 5 weight percent to about 7.5 weight percent, from about 7.5 weight percent to about 15 weight percent, from about 15 weight percent to about 25 weight percent, from about 25 weight percent to about 50 weight percent, from about 50 weight percent to about 65 weight percent, from about 65 weight percent to about 80 weight percent, or from about 80 weight percent to about 95 weight percent based on the weight of the electrolyte.

During use, the hydrophilic additives may absorb water vapor from air and may retain the water in the electrolyte. The presence of the hydrophilic additives in the electrolyte may reduce the equilibrium vapor pressure of the electrolyte. A relatively lower equilibrium vapor pressure may retain relatively more water in the electrolyte as liquid.

In one embodiment, the electrolyte is potassium hydroxide (KOH) and has a molarity of 6 mol/L. The KOH electrolyte may be mixed with PAA Na to form a KOH/PAA Na/water solution. The solution of KOH/PAA Na/water may absorb water as water vapor from ambient air into the electrolyte, and may retain that water within the electrochemical cell. This absorption of water from water vapor by PAA Na in the electrolyte may results in a net water retention even under conditions where the relative humidity of the vapor environment in the electrochemical cell is reduced because the equilibrium of the system favors retention of water in the electrolyte.

The KOH/PAA Na/water electrolyte solution may maintain water because when water evaporation increases, forming more water vapor, the KOH and PAA Na concentrations also increase within the electrolyte. As a consequence, evaporation of water from the electrolyte is decreased because the equilibrium vapor pressure for water favors retention of water in the electrolyte. The water concentration increase in the electrolyte continues until the vapor pressure favors water evaporation. This self-regulating water/water vapor dynamic may reduce or prevent a risk of the electrochemical cell drying out. This aspect may maintain a water balance in the cell within a determined range. For some embodiments, the PAA Na showed such effect up to about 80 0 times its weight in water.

While a KOH/PAA Na/water electrolyte has been described, it is understood that other hydroscopic additives, such as alcohols, amines and glycerin are usable within an aqueous electrolyte to reduce water loss from an electrochemical cell.

### EXAMPLES

The following examples are intended only to illustrate methods and embodiments in accordance with the invention, and as such should not be construed as imposing limitations upon the claims. Unless specified otherwise, all ingredients are commercially available from such common chemical suppliers as Alpha Aesar, Inc. (Ward Hill, Mass.) and/or Spectrum Chemical Mfg. Corp. (Gardena, Calif.).

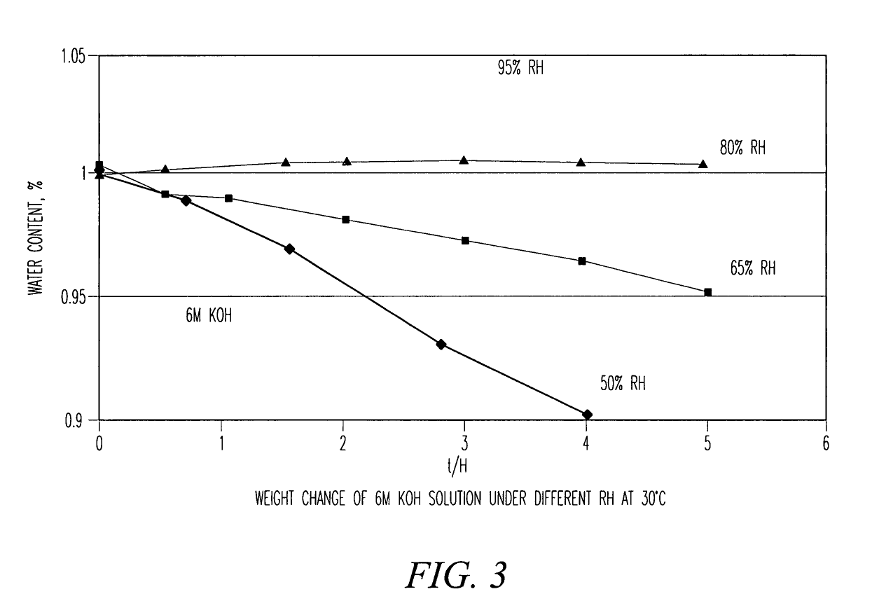

The same types of fuel cell are used for all of the examples presented herein. An electrolyte solution that includes 6M KOH and water may be used for all examples. Two control examples are run using pure water and 6 mol/L KOH, respectively, to test water retaining capability. The testing temperature is held at 30 degrees Celsius for a time of 5 hours. The relative humidity is in a range of from 50 percent to 95 percent. Testing is performed in a beaker. For each example, the weight of each sample is measured prior to initiation of the test and after one hour in a humidity control chamber. A ratio of the weight of pure water initially to its weight after testing from 1 hour to 5 hour is shown in FIG. 1. The plot for 6M KOH solution control is shown in FIG. 3.

### Example 1

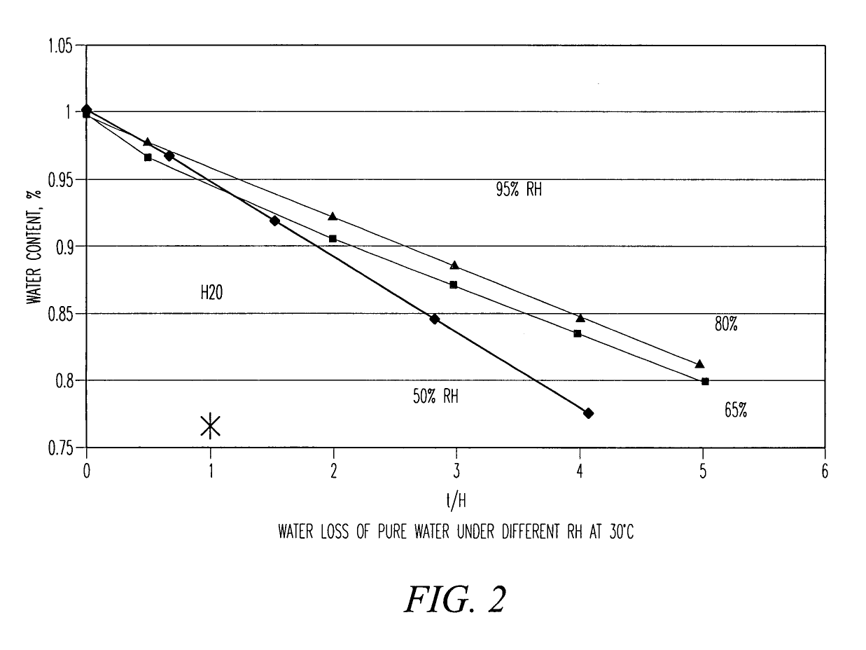

Example 1, illustrated schematically in FIG. 2, is a control example that includes sample 1 of water only, having no KOH and no additives. The sample is tested for a time of 5 hours. The water retention is measured at 50 percent, 65 percent, 80 percent, and 95 percent relative humidity for the 5 hours. The sample shows a loss of water of about 25 percent after 4 hour at a 50 percent relative humidity, as shown. The water content percentage at the relative humidity of 65 percent, 80 percent and 95 percent shows a decrease over the 5 hour period, from 1 to about 0.8. The control sample loses weight due to escape/evaporation based on relative humidity.

### Example 2

Example 2, illustrated schematically in FIG. 3, is a control example that includes sample 2, which includes a 6 molar/L KOH solution only, having no additives. It is tested for a time of 5 hours. The water retention is measured at 50 percent, 65 percent, 80 percent, and 95 percent relative humidity for the 5 hours. The sample shows a loss of water of about 10 percent within 4 hours at a 50 percent relative humidity, as shown. The water content percentage at the relative humidity of 80 percent and at 95 percent shows an increase in water content over the 5 hour period, as compared to the water content at the beginning of the test. The water content percentage at a relative humidity of 65 percent shows a decrease in percent water content from 1 to about 0.96. The 6 molar/L KOH control displays an equilibrium between a relative humidity of 65 percent and 80 percent. At 65 percent relative humidity, it lost water. At 80 percent relative humidity, it gained water.

### Example 3

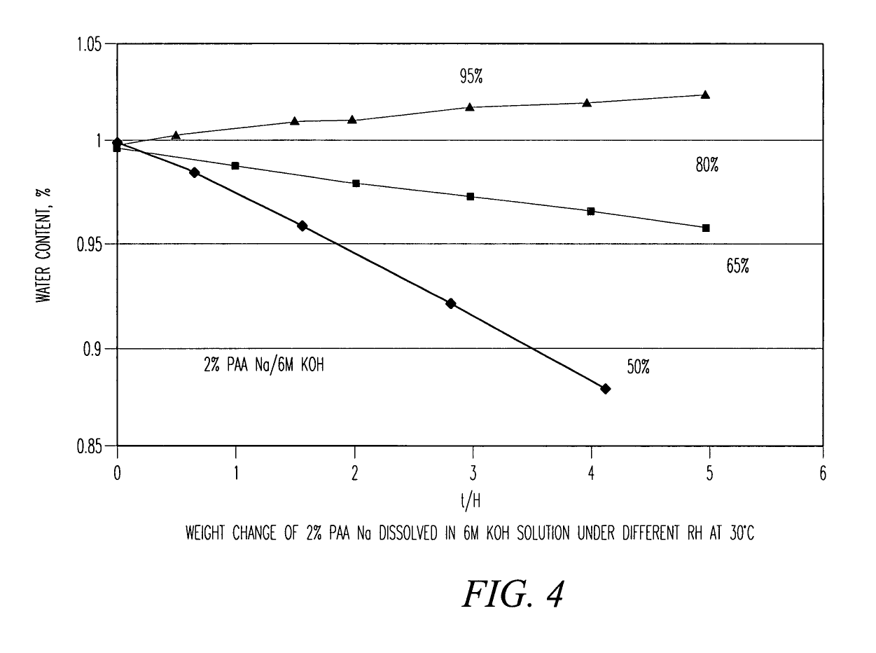

Example 3, illustrated schematically in FIG. 4, includes sample 3, which has 6 molar/L KOH and a PAA Na additive. The PAA Na additive is present in a concentration of 2 percent by weight of the electrolyte. The sample is tested for a time of 5 hours. The water content is measured at 50 percent, 65 percent, 80 percent, and 95 percent relative humidity for the 5 hours. The fuel cell shows a loss of water of about 15 percent within 4 hours at a 50 percent relative humidity, as shown. The sample shows a water content change from 1 weight to about 0.96 weight percent at 65 percent relative humidity over the 5 hour period. It showed a gain in water over the 5 hour period at relative humidity of 80 percent and 95 percent.

### Example 4

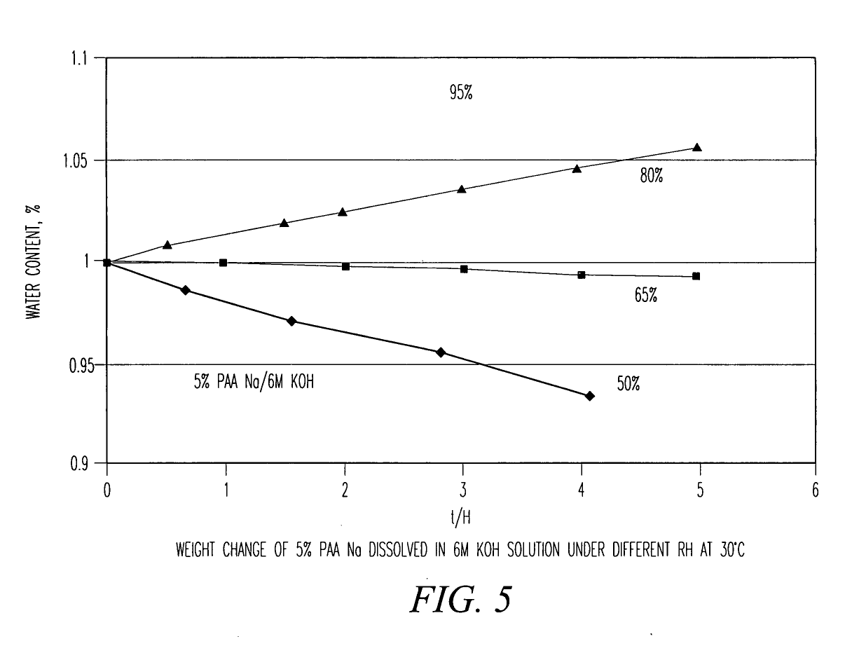

Example 4, illustrated schematically in FIG. 5, includes sample 4, which has a 6 molar/L KOH electrolyte and a PAA Na additive. The PAA Na additive is present in a concentration of 5 percent by weight of the electrolyte. The sample is operated for a time of 5 hours. The water content is measured at 50 percent, 65 percent, 80 percent, and 95 percent relative humidity for the 5 hours. The fuel cell showed a loss of water of about 15 percent within 4 hours at a 50 percent relative humidity, as shown. The sample shows a very small water content change at 65 percent relative humidity over the 5 hour period. The sample shows a gain in water over the 5 hour period at relative humidity values of 80 percent and 95 percent.

The results show that the water loss rate at 65 percent relative humidity is reduced in tests that include 6 molar/L KOH and the PAA Na additive at 2 percent and at the 5 percent concentration. The 5 percent PAA Na additive shows a greater reduction in water loss than the 2 percent PAA Na. The absorbing rate of water vapor at 80 percent relative humidity increases with increasing concentration of PAA Na in the electrolyte.

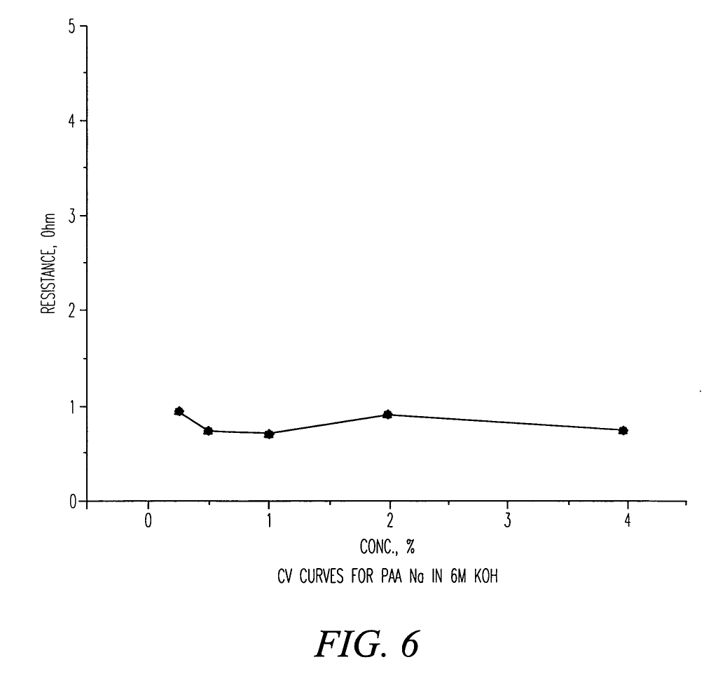

In addition to having hydroscopic properties, suitable additives may not reduce the conductivity of the electrolyte, as is illustrated schematically in FIG. 6. FIG. 6 illustrates that the conductivity data after adding PAA Na in 6 molar/L KOH is not significantly changed.

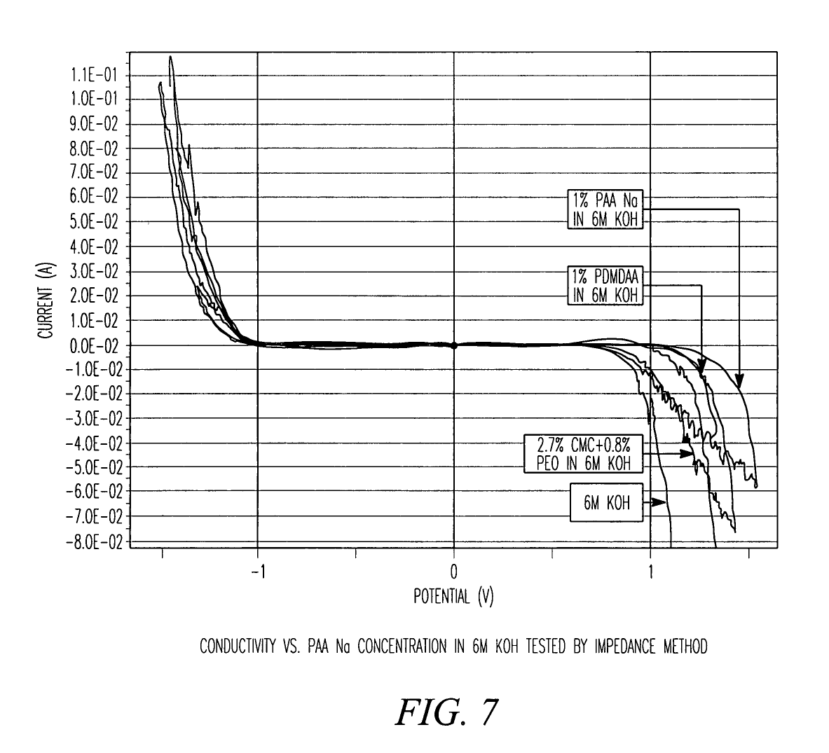

The electrochemical stability of 1 percent PAA Na in 6 mol/L KOH in one embodiment is shown schematically in FIG. 7. FIG. 7 illustrated that the cyclic voltammetric curves for 6 mol/L KOH electrolyte that include an additive having the same shape, curve or slope as 6 mol/L KOH solution within the potential range. Additives described herein display stability over the charging/discharging process.

A method and a apparatus for reducing water loss in a rechargeable fuel cells described herein may apply to power generation in general. The embodiments may apply to transportation applications, portable power sources, home and commercial power generation, large power generation and to any other application that would benefit from the use of such a system.

In the description of some embodiments of the invention, reference has been made to the accompanying drawings which form a part hereof, and in which are shown, by way of illustration, specific embodiments of the invention which may be practiced. In the drawings, like numerals describe substantially similar components throughout the several views. These embodiments are described in sufficient detail to enable one of ordinary skill in the art to practice the invention. Other embodiments may be utilized and structural, logical, and electrical changes may be made without departing from the scope of the invention. The detailed description is not to be taken in a limiting sense, and the scope of the invention is defined only by the appended claims, along with the full scope of equivalents to which such claims are entitled.

1. An electrochemical cell, comprising:
at least one anode;
at least one cathode; and
an electrolyte composition contacting the anode and cathode, the electrolyte composition comprising an alkali and a hydrophilic additive.

2. The electrochemical cell of claim 1, wherein the electrolyte composition comprises sodium polyacrylate.

3. The electrochemical cell of claim 1, wherein the hydrophilic additive has a molecular weight of about 3,000,000.

4. The electrochemical cell of claim 1, wherein the hydrophilic additive comprises one or more polytheylene oxide, carboxymethylcellulose, alcohols, or amines.

5. The electrochemical cell of claim 1, wherein the hydrophilic additive comprises one or more functional groups effective for bonding with water.

6. The electrochemical cell of claim 1, wherein the hydrophilic additive is present in the electrolyte in an amount in a range of from about 1 weight percent to about 95 weight percent.

7. The electrochemical cell of claim 1, wherein the electrolyte comprises an alkaline hydroxide.

8. The electrochemical cell of claim 7, wherein the electrolyte comprises potassium hydroxide.

9. The electrochemical cell of claim 1, wherein the electrochemical cell is a fuel cell.

10. The electrochemical cell of claim 1, wherein the electrochemical cell is a battery.

11. A composition, comprising:
an electrolyte comprising water and an alkali; and
a hydrophilic additive.

12. The composition as defined in claim 11, wherein the alkali is potassium hydroxide; and, the hydrophilic additive comprises an alcohol or an amine, and has a molecular weight greater than 500,000.

13. An electrochemical cell stack comprising two or more of the electrochemical cells of claim 1.

14. A method, comprising:
adding a hydrophilic additive to an aqueous electrolyte to form an electrolyte composition, wherein the hydrophilic additive has one or more functional groups effective for bonding with water; and
reducing water loss in an electrochemical cell comprising electrolyte composition.

15. The method of claim 14, wherein the hydrophilic additive is added in a concentration in a range of from about 2 weight percent to about 5 weight percent based on the weight of the electrolyte composition.

16. The method of claim 14, wherein the hydrophilic additive comprises one or more of polyacrylate, glycerin, polytheylene oxide, carboxymethylcellulose, alcohol, or amine.

17. A method for stabilizing relative humidity in an electrochemical cell comprising water and an electrolyte, the method comprising:
adding a hydrophilic additive having one or more functional groups effective for bonding with water to the electrolyte.

18. The method of claim 15, wherein the hydrophilic additive comprises one or more of polyacrylate, glycerin, polytheylene oxide, carboxymethylcellulose, alcohol, or amine.

19. The method of claim 16, wherein the hydrophilic additive is added in a concentration in a range of from about 2 weight percent to about 5 weight percent based on the weight of the electrolyte composition.

20. The method of claim 16, wherein the relative humidity stability is maintained at less than 60 percent relative humidity.

21. The method of claim 20, wherein the relative humidity stability is maintained at about 55 percent relative humidity.
